(19) United States
(12) Patent Application Publication
(10) Pub. No.: US 2026/0145741 A1
(43) Pub. Date: May 28, 2026

(54) SIDE SILL ROTATION PREVENTION DEVICE FOR VEHICLE

(71) Applicants: HYUNDAI MOTOR COMPANY, Seoul (KR); Kia Corporation, Seoul (KR)

(72) Inventors: Tae Soo PARK, Hwaseong-si (KR); Gun Woo KO, Hwaseong-si (KR)

(21) Appl. No.: 19/244,559

(22) Filed: Jun. 20, 2025

(30) Foreign Application Priority Data
Nov. 22, 2024 (KR) 10-2024-0167967

(51) Int. Cl. B62D 21/15; B60K 1/04; B60L 50/60; B60N 2/005; B62D 25/02; B62D 27/06; H01M 50/249

(52) U.S. Cl. CPC B62D 21/157; B60K 1/04; B60L 50/66; B62D 25/025; B62D 27/065; H01M 50/249; B60K 2001/0422; B60N 2/005; H01M 2220/20

(57) ABSTRACT

Disclosed is a side sill rotation prevention device for a vehicle, the side sill rotation prevention device including a pair of side sill inner panels, a seat cross bar disposed between the pair of side sill inner panels, and a plurality of extension brackets configured to connect the side sill inner panel to the seat cross bar, wherein each of the extension bracket includes an extension lower bracket configured to connect the side sill inner panel to the seat cross bar, and an extension upper bracket connected to the extension lower bracket, the extension upper bracket being configured to suppress rotation of the side sill inner panel.

### CROSS-REFERENCE TO RELATED APPLICATION

This application claims, under 35 U.S.C. § 119(a), the benefit of priority from Korean Patent Application No. 10-2024-0167967, filed on Nov. 22, 2024, the entire contents of which are incorporated herein by reference.

### TECHNICAL FIELD

The present disclosure relates to a side sill rotation prevention device for a vehicle, and more particularly, to a side sill rotation prevention device configured to prevent rotation of a side sill and securing vehicle safety in the event of vehicle side collision.

### BACKGROUND

A vehicle may include a side sill and a side sill reinforcement member that are provided on the lower end side of a vehicle body. The side sill and the side sill reinforcement member may improve collision performance in the event of vehicle side collision and secure a passenger survival space in the vehicle interior. In some cases, the side sill and the side sill reinforcement member may help prevent vehicle fire by protecting a battery in the event of vehicle side collision.

In order to secure collision performance of the vehicle, the side sill and the side sill reinforcement member may have a structure derived through analysis, evaluation, and verification of the cross-sectional shape, size, and location thereof.

In some cases, electric vehicles may have a battery-mounted structure including a cell array and a supporting element. In some cases, electric vehicles may have a structure in which a vehicle body and a battery are integrated with each other.

When excessive rotation of the side sill occurs due to side collision of an electric vehicle, a battery module inside a battery case may be damaged due to rotation of the side wall of the battery case. In addition, when the side sill is excessively rotated, a vehicle body pillar may be excessively deformed, which may cause a negative effect on securing the passenger survival space inside the vehicle. Research and development have been conducted to reduce and prevent rotation of the side sill.

### SUMMARY

The present disclosure describes a side sill rotation prevention device for a vehicle, configured to improve collision performance and safety of the vehicle by reducing rotation of a side sill in the event of vehicle side collision.

According to one aspect of the subject matter described in this application, a side sill rotation prevention device for a vehicle includes a seat cross bar, a side sill inner panel disposed at a longitudinal side of the seat cross bar, and a plurality of extension brackets that connect the side sill inner panel to the seat cross bar. The plurality of extension brackets include an extension lower bracket that connects the side sill inner panel to the seat cross bar, and an extension upper bracket connected to the extension lower bracket and configured to suppress rotation of the side sill inner panel.

Implementations according to this aspect can include one or more of the following features. For example, the extension lower bracket can include a lower bracket body coupled to the seat cross bar, and a first lower flange disposed at an edge of the lower bracket body and coupled to the side sill inner panel. In some examples, the extension upper bracket can include a first upper flange coupled to the side sill inner panel and the extension lower bracket.

In some implementations, the first upper flange can be coupled to an upper wall part of the side sill inner panel, and the extension upper bracket can include an upper bracket body extending from the first upper flange, where the upper bracket body is disposed along a straight line with the upper wall part of the side sill inner panel.

In some implementations, the first lower flange can be disposed between the first upper flange and the side sill inner panel. In some examples, the lower bracket body can include a first lower mounting part disposed on the seat cross bar, the first lower mounting part defining a plurality of first coupling holes, a second lower mounting part that is disposed on the seat cross bar and extends from the first lower mounting part toward the first lower flange, the second lower mounting part defining a plurality of second coupling holes, and a lower inclined part that obliquely extends from the second lower mounting part toward the first lower flange.

In some examples, the extension upper bracket can include a second upper flange coupled to the first lower mounting part, the second upper flange defining a plurality of upper coupling holes, and an upper inclined part that obliquely extends from the upper bracket body toward the second upper flange.

In some implementations, the upper bracket body can be disposed above the lower bracket body and define a plurality of screw passing holes, where each of the plurality of screw passing holes is defined along a line passing through a corresponding one of the plurality of second coupling holes.

In some implementations, the extension lower bracket can include a pair of lower bracket side walls that are bent and extend from the lower bracket body, and the extension upper bracket can include a pair of upper bracket side walls that are bent and extend from the upper bracket body, where the pair of upper bracket side walls are respectively coupled to the pair of lower bracket side walls.

In some examples, the pair of upper bracket side walls include a first upper bracket side wall and a second upper bracket side wall, and the extension upper bracket further can include (i) a third upper flange that is bent and extends from the first upper bracket side wall and (ii) a fourth upper flange that is bent and extends from the second upper bracket side wall. The third upper flange and the fourth upper flange can be coupled to a side wall part of the side sill inner panel.

In some implementations, the pair of lower bracket side walls include a first lower bracket side wall and a second lower bracket side wall, and the extension lower bracket further can include (i) a second lower flange that is bent and extends from the first lower bracket side wall and (ii) a third lower flange that is bent and extends from the second lower bracket side wall. The second lower flange and the third lower flange can be coupled to a side wall part of the side sill inner panel.

In some implementations, the side sill rotation prevention device can further include a side sill reinforcement member disposed at the side sill inner panel, where the seat cross bar is disposed along a horizontal line passing through the side sill reinforcement member.

In some implementations, the first upper flange can be coupled to the side sill inner panel and the first lower flange through welding, where the lower bracket body is coupled to the seat cross bar through bolting.

In some implementations, the side sill inner panel can include a lower wall part configured to be coupled to a side member of a battery case, where the battery case can include a lower case that includes the side member, and an upper case coupled to the seat cross bar, the upper case being disposed above and coupled to an upper end of the lower case. In some examples, the seat cross bar can include a cross member body configured to be disposed between the upper case of the battery case and the extension lower bracket, the cross member body being coupled to the extension lower bracket, and a joining flange that extends from a lower end of the cross member body, the joining flange being configured to be disposed on and coupled to the upper case of the battery case.

In some examples, the seat cross bar can include a bar disposed below a seat of the vehicle.

It is understood that the terms “vehicle,” “vehicular,” and other similar terms as used herein are inclusive of motor vehicles in general, such as passenger automobiles including sport utility vehicles (SUVs), buses, trucks, various commercial vehicles, watercraft including a variety of boats and ships, aircraft, and the like, and include hybrid vehicles, electric vehicles, plug-in hybrid electric vehicles, hydrogen-powered vehicles, and other alternative fuel vehicles (e.g., fuels derived from resources other than petroleum). As referred to herein, a hybrid vehicle is a vehicle that has two or more sources of power, for example, vehicles powered by both gasoline and electricity.

### BRIEF DESCRIPTION OF THE DRAWINGS

The above and other features of the present disclosure will now be described in detail with reference to certain implementations thereof illustrated in the accompanying drawings which are given hereinbelow by way of illustration only, and thus are not limitative of the present disclosure.

FIG. 1 is an exploded perspective view showing an example of a side sill rotation prevention device.

FIG. 2 is an assembled perspective view showing the side sill rotation prevention device.

FIG. 3 is a cross-sectional view taken along line A-A in FIG. 2.

FIGS. 4 and 5 are exploded perspective views showing an example of extension brackets.

FIG. 6 is a view showing an example of an assembly sequence of the side sill rotation prevention device.

FIG. 7 is a view showing an example of a connection structure between a side sill and a battery.

FIG. 8 is a cross-sectional view showing an example of seat legs mounted on an extension bracket.

In the figures, reference numbers refer to the same or equivalent parts of the present disclosure throughout the several figures of the drawing.

### DETAILED DESCRIPTION

Hereinafter, reference will be made in detail to various implementations of the present disclosure, examples of which are illustrated in the accompanying drawings and described below. Further, the matters represented in the accompanying drawings are schematically illustrated in order to easily explain the implementations of the present disclosure, and can be different from actually implemented forms.

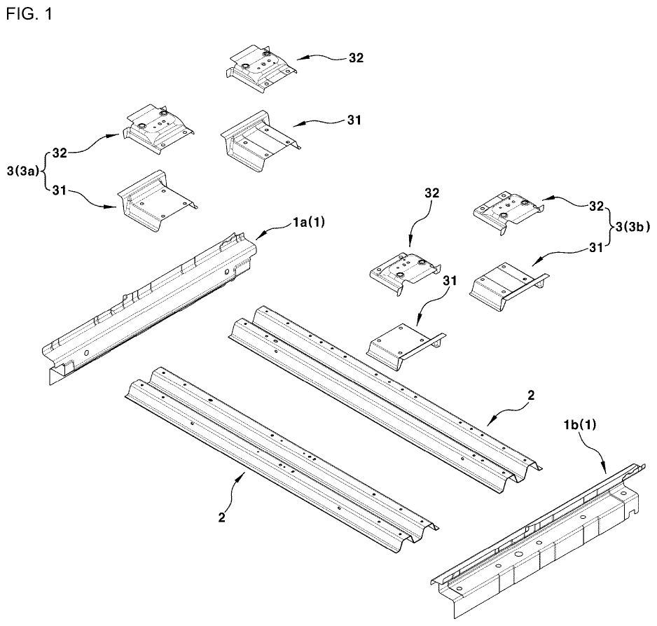

In some implementations, as shown in FIG. 1, a side sill rotation prevention device for a vehicle can include a pair of side sill inner panels 1, a plurality of seat cross bars 2 disposed between the pair of side sill inner panels 1, and a plurality of extension brackets 3 configured to connect the side sill inner panels 1 to the seat cross bars 2.

The side sill inner panels 1 are components each configured to secure side collision performance of a vehicle body and are respectively disposed at the lower left end and the lower right end of the vehicle body. Each of the side sill inner panels 1 can extend in the forward-and-rearward direction of the vehicle.

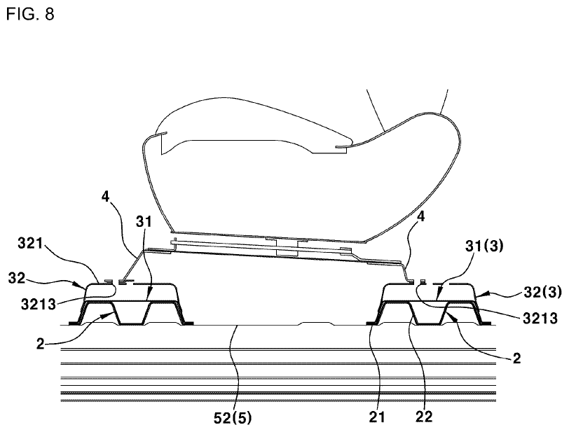

The seat cross bars 2 are disposed between the pair of side sill inner panels 1 and are disposed below a seat 41 (see FIG. 8) configured for a user to sit thereon. Each of the seat cross bars 2 is formed to extend in the left-and-right direction. The side sill inner panels 1 are respectively disposed on opposite sides (that is, the left side and the right side) of the seat cross bars 2 in the longitudinal direction. For example, the seat cross bar 2 can include a bar that is disposed below the seat 41 of the vehicle and extend horizontally across the seat 41.

In some implementations, all of the plurality of seat cross bars 2 can have first ends and second ends connected to the pair of side sill inner panels 1. The first end of the seat cross bar 2 is connected to a first side sill inner panel 1a via a first extension bracket 3a, and the second end of the seat cross bar 2 is connected to a second side sill inner panel 1b via a second extension bracket 3b.

In some examples, a structural configuration in which the first end of the seat cross bar 2 is connected to the first side sill inner panel 1a via the first extension bracket 3a is substantially equal to a structural configuration in which the second end of the seat cross bar 2 is connected to the second side sill inner panel 1b via the second extension bracket 3b. In addition, the first extension bracket 3a and the second extension bracket 3b can be configured to have the same structure.

Therefore, in the present specification, a description will be given as to a connection structure between the seat cross bar 2 and the side sill inner panel 1 using any one of the first extension bracket 3a or the second extension bracket 3b.

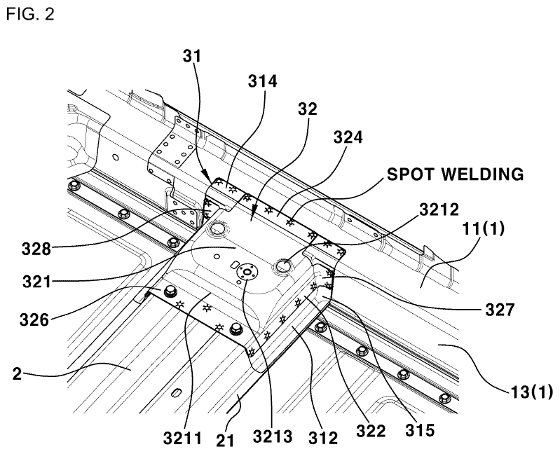

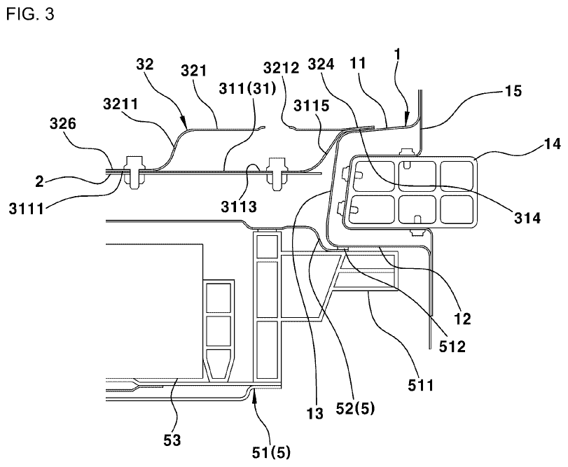

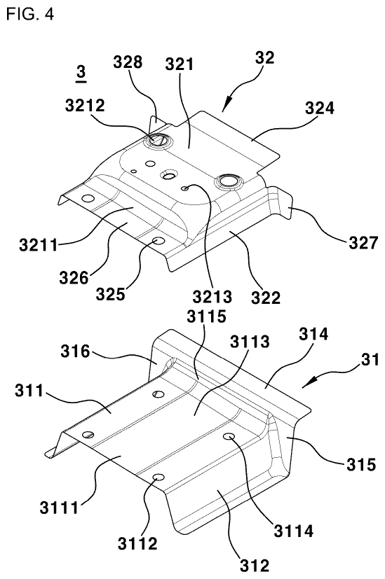

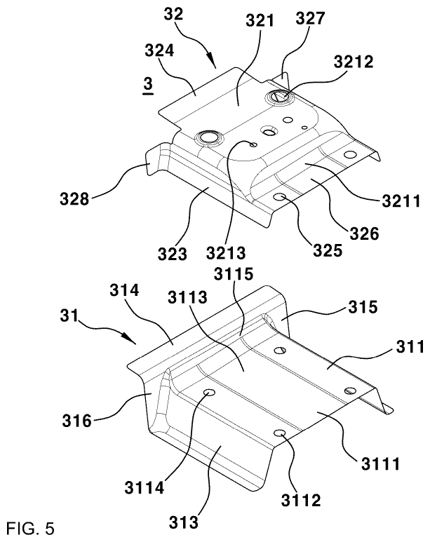

In some implementations, as shown in FIGS. 2 and 3, the seat cross bar 2 and the side sill inner panel 1 are connected to each other via the extension bracket 3. As shown in FIGS. 4 and 5, the extension bracket 3 can include an extension lower bracket 31 and an extension upper bracket 32. The extension lower bracket 31 and the extension upper bracket 32 can be molded by a press method using steel having a grade of 60K or higher.

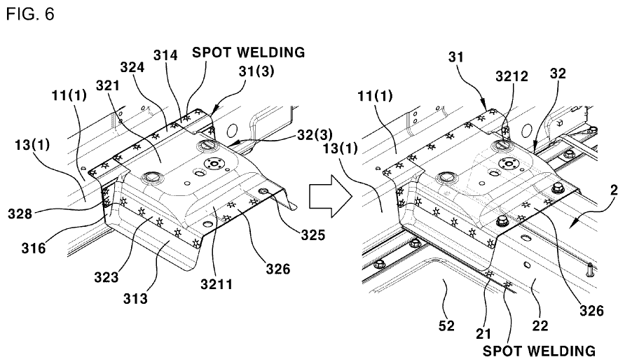

In some examples, in the case of a vehicle in which the upper portion of a battery case 5 (that is, an upper case 52) serves as the floor panel of the vehicle body (that is, a vehicle in which a battery and a vehicle body are formed to be integrated with each other), as shown in FIG. 6, the lower portion of the seat cross bar 2 is joined to the upper case 52 by welding.

In some implementations, the seat cross bar 2 applied to a vehicle in which a battery and a vehicle body are formed to be integrated with each other may not be connected to the extension bracket 3 by welding. The reason for this is that a welding gun may not enter the lower portion of the seat cross bar 2. When the seat cross bar 2 is joined to the upper case 52, the seat cross bar 2 and the upper case 52 form a closed cross section. Therefore, it is impossible to join the seat cross bar 2 to the extension bracket 3 by spot welding. In some examples, the extension bracket 3 is joined to the seat cross bar 2 by bolting.

In some implementations, the extension lower bracket 31 can be configured to physically connect the side sill inner panel 1 to the seat cross bar 2. The extension lower bracket 31 is connected to the seat cross bar 2 through bolting. In more detail, the extension lower bracket 31 connects the lateral end of the seat cross bar 2 to the side sill inner panel 1 through welding and bolting. That is, the extension lower bracket 31 is connected to the side sill inner panel 1 through welding and is connected to the lateral end of the seat cross bar 2 through bolting.

In some examples, the extension lower bracket 31 can include a lower bracket body 311, a pair of lower bracket side walls 312 and 313, and a plurality of lower flanges 314, 315, and 316.

For example, the lower bracket body 311 can have a flat plate structure and be stacked on and joined to the upper portion of the seat cross bar 2. The lower bracket body 311 can be joined to the seat cross bar 2 through bolting using bolts and nuts. In some examples, the lower bracket body 311 includes a first lower mounting part 3111 and a second lower mounting part 3113.

The first lower mounting part 3111 can define a plurality of first coupling holes 3112, and the second lower mounting part 3113 can define a plurality of second coupling holes 3114. The first coupling holes 3112 are spaced apart from each other in the forward-and-rearward direction, and the second coupling holes 3114 are also spaced apart from each other in the forward-and-rearward direction. Bolts are respectively inserted through the first coupling holes 3112 and the second coupling holes 3114 for an assembly process. The second lower mounting part 3113 is located between the first lower mounting part 3111 and the first lower flange 314.

The lower bracket body 311 is provided with the second lower mounting part 3113 and the first lower mounting part 3111, thereby achieving more stable coupling with the seat cross bar 2.

In some implementations, the pair of lower bracket side walls 312 and 313 can be bent and extend from the lower bracket body 311. The first lower bracket side wall 312 can be bent and extend rearwards from the rear edge of the lower bracket body 311, and the second lower bracket side wall 313 can be bent and extend rearwards from the front edge of the lower bracket body 311. In some cases, an angle formed between the lower bracket body 311 and the lower bracket side walls 312 and 313 can be an obtuse angle.

The first lower flange 314 is disposed on the opposite side of the first lower mounting part 3111 with the second lower mounting part 3113 interposed therebetween. The first lower flange 314 is provided on the right edge of the lower bracket body 311 and is joined to an upper wall part 11 of the side sill inner panel 1.

As shown in FIG. 3, there is a height difference between the upper portion of the seat cross bar 2 and the upper wall part 11 of the side sill inner panel 1 in the vertical direction. Accordingly, the lower bracket body 311 includes a lower inclined part 3115 formed to extend upwards between the second lower mounting part 3113 and the first lower flange 314.

In some implementations, the second lower flange 315 can be bent and extend from the first lower bracket side wall 312, and the third lower flange 316 can be bent and extend from the second lower bracket side wall 313. More specifically, the second lower flange 315 can be bent and extend rearwards from the right edge of the first lower bracket side wall 312. The third lower flange 316 can be bent and extend forwards from the right edge of the second lower bracket side wall 313. In some examples, the right edges of the first lower bracket side wall 312 and the second lower bracket side wall 313 are edges facing the outside of the vehicle.

The second lower flange 315 and the third lower flange 316 can extend to the edge of the lower inclined part 3115 and the edge of the first lower flange 314. The second lower flange 315 and the third lower flange 316 are joined and fixed to a side wall part 13 of the side sill inner panel 1 by welding.

The side sill inner panel 1 is formed to have a curved structure so as to have a rectangular cross section having one open side. The side sill inner panel 1 includes the upper wall part 11 and a lower wall part 12, and a side wall part 13 extending between the upper wall part 11 and the lower wall part 12. The side wall part 13 extends downwards from one end of the upper wall part 11 and extends to one end of the lower wall part 12. In some examples, one end of the upper wall part 11 and one end of the lower wall part 12 are ends facing the interior of the vehicle.

As shown in FIGS. 2 to 5, the extension upper bracket 32 is connected to the extension lower bracket 31 by welding and supports the side sill inner panel 1 in the event of vehicle side collision, thereby reducing or preventing rotation of the side sill inner panel 1. The extension upper bracket 32 prevents the side sill inner panel 1 from being pushed and rotated by collision energy applied to the vehicle body in the lateral direction in the event of vehicle side collision.

The extension upper bracket 32 is joined to the extension lower bracket 31 and the side sill inner panel 1 by spot welding.

Specifically, the extension upper bracket 32 includes an upper bracket body 321, a pair of upper bracket side walls 322 and 323, and a plurality of upper flanges 324, 326, 327, and 328.

The upper bracket body 321 is connected to the extension lower bracket 31 and the side sill inner panel 1 through the first upper flange 324. The first upper flange 324 is stacked on and welded to the upper wall part 11 of the side sill inner panel 1, and the upper bracket body 321 extends laterally from the first upper flange 324. In this case, the upper bracket body 321 can extend horizontally with the first upper flange 324 and is located in a straight line with the upper wall part 11 of the side sill inner panel 1.

Since the upper bracket body 321 is located in the straight line with the upper wall part 11 of the side sill inner panel 1, the extension upper bracket 32 can effectively prevent rotation of the side sill inner panel 1 in the event of vehicle side collision.

In some examples, the extension upper bracket 32 can also prevent rotation of a side sill reinforcement member 14 disposed in the inner space of the side sill inner panel 1. The inner space of the side sill inner panel 1 is a space surrounded by the upper wall part 11, the lower wall part 12, and the side wall part 13. As shown in FIG. 3, the side sill reinforcement member 14 is mounted and disposed in the inner space of the side sill inner panel 1 through a mounting bracket 15. The mounting bracket 15 is joined and fixed to the side sill inner panel 1 by welding. The side sill reinforcement member 14 is supported in a state of being inserted into and disposed in the inner space of the side sill inner panel 1 by the mounting bracket 15. The side sill reinforcement member 14 can be made of aluminum.

In addition, the upper bracket body 321 is located on the same line as the upper wall part 11 of the side sill inner panel 1 and is located above the lower bracket body 311 with a predetermined distance therebetween.

Additionally, referring to FIG. 8, the upper bracket body 321 has a seat mounting hole 3213 through which a seat leg 4 is mounted. That is, the upper bracket body 321 includes the seat mounting hole 3213 configured to couple the upper bracket body 321 to the seat leg 4. The seat leg 4 can be an outer leg provided on a seat in the first row (that is, a front seat) of a vehicle.

In some implementations, the pair of upper bracket side walls 322 and 323 can be bent and extend from the upper bracket body 321. The first upper bracket side wall 322 can be bent and extend downwards from the rear edge of the upper bracket body 321, and the second upper bracket side wall 323 can be bent and extend downwards from the front edge of the upper bracket body 321. The first upper bracket side wall 322 and the second upper bracket side wall 323 are respectively joined to the first lower bracket side wall 312 and the second lower bracket side wall 313 by spot welding.

In some examples, the upper bracket body 321 has an upper inclined part 3211 provided at one edge thereof and formed to obliquely extend downwards. The upper inclined part 3211 extends between the upper bracket body 321 and the second upper flange 326. The second upper flange 326 is bent from the lower end of the upper inclined part 3211 and extends in the lateral direction. The second upper flange 326 is disposed on the opposite side of the first upper flange 324 with the upper bracket body 321 interposed therebetween. The second upper flange 326 is joined to the first lower mounting part 3111 by welding.

In some implementations, the second upper flange 326 can be disposed and extend between the first end of the first upper bracket side wall 322 and the first end of the second upper bracket side wall 323. In some examples, the first end of the first upper bracket side wall 322 and the first end of the second upper bracket side wall 323 are portions extending farther toward the vehicle center than the upper bracket body 321. More specifically, the second upper flange 326 extends from the upper edge of the first upper bracket side wall 322 to the upper edge of the second upper bracket side wall 323.

In some examples, the third upper flange 327 can be bent and extend rearwards from the second end of the first upper bracket side wall 322. The fourth upper flange 328 can be bent and extend forwards from the second end of the second upper bracket side wall 323. The third upper flange 327 and the fourth upper flange 328 are joined to the side wall part 13 of the side sill inner panel 1 by welding.

In some examples, the third upper flange 327 is joined to the side wall part 13 of the side sill inner panel 1 with the second lower flange 315 interposed therebetween, and the fourth upper flange 328 is joined to the side wall part 13 of the side sill inner panel 1 with the third lower flange 316 interposed therebetween.

In some examples, the first upper flange 324 is stacked on and joined to the upper wall part 11 of the side sill inner panel 1 with the first lower flange 314 interposed therebetween. In other words, the first lower flange 314 is disposed and joined between the first upper flange 324 and the upper wall part 11.

As shown in FIG. 6, the seat cross bar 2 is stacked and disposed on the lower side of the extension lower bracket 31 after the extension upper bracket 32 and the extension lower bracket 31 are joined to the upper wall part 11 and the side wall part 13 of the side sill inner panel 1 through spot welding. In some examples, the first lower mounting part 3111 is stacked and disposed between the second upper flange 326 and the seat cross bar 2. In addition, the second lower mounting part 3113 is stacked and disposed on the upper side of the seat cross bar 2 from the lower side of the upper bracket body 321.

Accordingly, in order to bolt the first lower mounting part 3111 to the seat cross bar 2, a plurality of upper coupling holes 325 is provided in the second upper flange 326. When the first lower mounting part 3111 is bolted to the seat cross bar 2, the second upper flange 326 is bolted and connected to the seat cross bar 2 through the upper coupling hole 325.

In addition, in order to bolt the second lower mounting part 3113 to the seat cross bar 2, the upper bracket body 321 has a plurality of screw passing holes 3212 formed therein. In order to bolt the second lower mounting part 3113 thereto, the screw passing holes 3212 are located above the second coupling holes 3114 formed in the second lower mounting part 3113. That is, the screw passing holes 3212 are located on the same vertical line as the second coupling holes 3114. The bolting operation of the second lower mounting part 3113 is performed through the screw passing holes 3212.

Further, as shown in FIG. 3, in order to improve reinforcement efficiency of the side sill reinforcement member 14, the seat cross bar 2 is disposed on the same line as the side sill reinforcement member 14. Specifically, the seat cross bar 2 is disposed on the same horizontal line as the upper portion of the side sill reinforcement member 14. Accordingly, reinforcement efficiency of the side sill reinforcement member 14 is increased, and the cross-sectional area of the side sill reinforcement member 14 can be reduced and as such, the weight thereof can be reduced.

Additionally, as shown in FIG. 6, the seat cross bar 2 is stacked on the lower side of the extension bracket 3 in a state of being joined to the battery case 5 and is combined with the extension bracket 3. The seat cross bar 2 has a joining flange 21 joined to the upper case 52 of the battery case 5 through spot welding. The joining flange 21 is provided on the lower portion of the seat cross bar 2.

Specifically, the seat cross bar 2 is configured to include a cross member body 22 and the joining flange 21. The cross member body 22 is stacked on the upper end of the upper case 52 and is disposed between the extension lower bracket 31 and the upper case 52. The cross member body 22 is bolted to the extension lower bracket 31.

The joining flange 21 extends from the lower end of the cross member body 22 and is stacked on and joined to the upper end of the upper case 52. The joining flange 21 is bent from the lower end of the cross member body 22 and extends to the outside of the cross member body 22. The joining flange 21 is provided at the front lower end and the rear lower end of the cross member body 22, respectively.

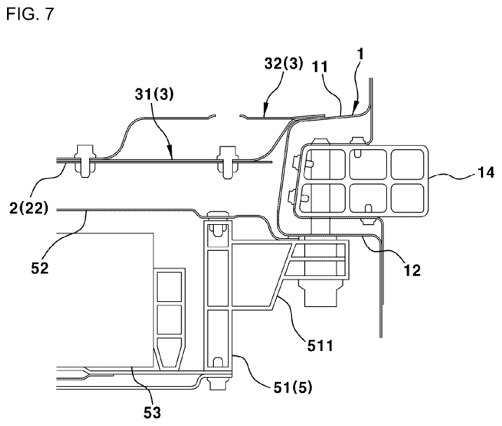

As shown in FIG. 7, the battery case 5 is also joined to the lower wall part 12 of the side sill inner panel 1. The battery case 5 includes a lower case 51 and the upper case 52.

The lower case 51 has an internal space formed for a battery module 53 to be stored therein, and has a side member 511 bolted to the lower wall part 12 of the side sill inner panel 1. The side member 511 protrudes from the side wall of the lower case 51 and extends toward the side sill inner panel 1. For example, the side member 511 can include a block protrudes from the side wall of the lower case 51 and extends toward the side sill inner panel 1. The side member 511 is stacked and disposed below the lower wall part 12 of the side sill inner panel 1. As shown in FIG. 3, a sealing foam 512 for watertightness is provided between the side member 511 and the lower wall part 12 on the upper portion of the side member 511.

The upper case 52 is configured to open and close the upper end of the lower case 51 and is stacked on and joined to the upper end of the lower case 51. The upper case 52 is joined to and stacked on the lower portion of the seat cross bar 2 and serves as a floor panel of the vehicle body. Therefore, the vehicle may not include a separate floor panel, and, as such, weight reduction can be possible.

In some examples, a side sill outer panel can cover the side sill reinforcement member 14, where the side sill outer panel is joined and fixed to the side sill inner panel 1.

The side sill rotation prevention device of the present disclosure configured as described above primarily absorbs collision energy generated when the side sill reinforcement member 14 is deformed in the event of vehicle side collision, and secondarily absorbs collision energy generated when the side wall of the lower case 51 is deformed. Next, when the side sill inner panel 1 is deformed and begins to be rotated toward the vehicle interior, the extension upper bracket 32 supports the side sill inner panel 1 and suppresses rotation of the side sill inner panel 1, thereby preventing further deformation and rotation of the lower case 51. Therefore, it is possible not only to prevent damage to the battery module 53 and intrusion of the side sill inner panel 1 into the vehicle interior, but also to secure a passenger survival space in the vehicle interior.

As is apparent from the above description, the present disclosure provides the following effects.

First, since an extension bracket connects a side sill inner panel to a seat cross bar through a double structure including an extension lower bracket and an extension upper bracket, thereby having an effect of reducing rotation of the side sill inner panel and a side sill reinforcement member and preventing excessive rotation of the side sill inner panel and the side sill reinforcement member in the event of vehicle side collision.

Second, in the event of vehicle side collision, it is possible not only to prevent damage to a battery module due to excessive rotation of the side sill inner panel, but also to secure a passenger survival space in the vehicle interior.

Third, since the side wall of the extension upper bracket and the side wall of the extension lower bracket are joined to each other, collision rigidity of the extension bracket is increased.

The effects of the present disclosure are not limited to the above-mentioned effects, and other effects not mentioned herein will be clearly understood by those skilled in the art from the detailed description of the implementations.

The implementations of the present disclosure have been described in detail above, and the terms or words used in this specification and claims shall not be construed as being limited to typical or dictionary meanings. In addition, since the implementations described in this specification and the configurations shown in the drawings are only implementations of the present disclosure, the scope of the present disclosure is not limited to the above-described implementations. Various modifications and improvements made by those skilled in the art using the basic concept of the present disclosure defined in the following claims also fall within the scope of the present disclosure.

What is claimed is:

1. A side sill rotation prevention device for a vehicle, the side sill rotation prevention device comprising:
a seat cross bar configured to be disposed below a seat of the vehicle;
a side sill inner panel disposed at a longitudinal side of the seat cross bar; and
a plurality of extension brackets that connect the side sill inner panel to the seat cross bar,
wherein the plurality of extension brackets comprise:
an extension lower bracket that connects the side sill inner panel to the seat cross bar, and
an extension upper bracket connected to the extension lower bracket and configured to suppress rotation of the side sill inner panel.

2. The side sill rotation prevention device of claim 1, wherein the extension lower bracket comprises:
a lower bracket body coupled to the seat cross bar; and
a first lower flange disposed at an edge of the lower bracket body and coupled to the side sill inner panel.

3. The side sill rotation prevention device of claim 2, wherein the extension upper bracket comprises a first upper flange coupled to the side sill inner panel and the extension lower bracket.

4. The side sill rotation prevention device of claim 3, wherein:
the first upper flange is coupled to an upper wall part of the side sill inner panel;
the extension upper bracket comprises an upper bracket body extending from the first upper flange; and
the upper bracket body is disposed along a straight line with the upper wall part of the side sill inner panel.

5. The side sill rotation prevention device of claim 3, wherein the first lower flange is disposed between the first upper flange and the side sill inner panel.

6. The side sill rotation prevention device of claim 4, wherein the lower bracket body comprises:
a first lower mounting part disposed on the seat cross bar, the first lower mounting part defining a plurality of first coupling holes;
a second lower mounting part that is disposed on the seat cross bar and extends from the first lower mounting part toward the first lower flange, the second lower mounting part defining a plurality of second coupling holes; and
a lower inclined part that obliquely extends from the second lower mounting part toward the first lower flange.

7. The side sill rotation prevention device of claim 6, wherein the extension upper bracket comprises:
a second upper flange coupled to the first lower mounting part, the second upper flange defining a plurality of upper coupling holes; and
an upper inclined part that obliquely extends from the upper bracket body toward the second upper flange.

8. The side sill rotation prevention device of claim 6, wherein the upper bracket body is disposed above the lower bracket body and defines a plurality of screw passing holes, each of the plurality of screw passing holes being defined along a line passing through a corresponding one of the plurality of second coupling holes.

9. The side sill rotation prevention device of claim 4, wherein:
the extension lower bracket comprises a pair of lower bracket side walls that are bent and extend from the lower bracket body;
the extension upper bracket comprises a pair of upper bracket side walls that are bent and extend from the upper bracket body; and
the pair of upper bracket side walls are respectively coupled to the pair of lower bracket side walls.

10. The side sill rotation prevention device of claim 9, wherein the pair of upper bracket side walls comprise a first upper bracket side wall and a second upper bracket side wall,
wherein the extension upper bracket further comprises (i) a third upper flange that is bent and extends from the first upper bracket side wall and (ii) a fourth upper flange that is bent and extends from the second upper bracket side wall, and
wherein the third upper flange and the fourth upper flange are coupled to a side wall part of the side sill inner panel.

11. The side sill rotation prevention device of claim 9, wherein the pair of lower bracket side walls comprise a first lower bracket side wall and a second lower bracket side wall,
wherein the extension lower bracket further comprises (i) a second lower flange that is bent and extends from the first lower bracket side wall and (ii) a third lower flange that is bent and extends from the second lower bracket side wall, and
wherein the second lower flange and the third lower flange are coupled to a side wall part of the side sill inner panel.

12. The side sill rotation prevention device of claim 1, further comprising a side sill reinforcement member disposed at the side sill inner panel,
wherein the seat cross bar is disposed along a horizontal line passing through the side sill reinforcement member.

13. The side sill rotation prevention device of claim 3, wherein the first upper flange is coupled to the side sill inner panel and the first lower flange through welding, and
wherein the lower bracket body is coupled to the seat cross bar through bolting.

14. The side sill rotation prevention device of claim 1, wherein the side sill inner panel comprises a lower wall part configured to be coupled to a side member of a battery case, and
wherein the battery case comprises:
a lower case that includes the side member; and
an upper case coupled to the seat cross bar, the upper case being disposed above and coupled to an upper end of the lower case.

15. The side sill rotation prevention device of claim 14, wherein the seat cross bar comprises:
a cross member body configured to be disposed between the upper case of the battery case and the extension lower bracket, the cross member body being coupled to the extension lower bracket; and
a joining flange that extends from a lower end of the cross member body, the joining flange being configured to be disposed on and coupled to the upper case of the battery case.
